(19) United States
(12) Patent Application Publication
(10) Pub. No.: US 2005/0055594 A1
(43) Pub. Date: Mar. 10, 2005

(54) Method and device for synchronizing a processor and a coprocessor

(76) Inventors: Andreas C. Doering, Adliswil (CH); Silvio Dragone, Adliswil (CH)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/924,185

(22) Filed: Aug. 23, 2004

(30) Foreign Application Priority Data
Sep. 5, 2003 (EP) 03020146.1

(51) Int. Cl. G06F 1/04

(52) U.S. Cl. 713/375; 712/34

(57) ABSTRACT

A system and method for synchronizing a processor and a coprocessor includes a processor and coprocessor working off a thread, wherein the thread includes a thread control instruction (stopthread) for controlling the timing of this thread. When the processor executes the thread control instruction this thread is stopped with the help of the thread control instruction until a wake up signal from the coprocessor allows the continuation of working off of this thread.

### TECHNICAL FIELD

The present invention relates to methods and a system for synchronizing a processor and a coprocessor, wherein the processor and the coprocessor are jointly working off one or more threads.

### BACKGROUND OF THE INVENTION

Coupling coprocessors to processors is a frequently occurring problem. Traditionally, the processors have been not as fast as today and it was possible to couple the processor and the coprocessor in lock-step.

Frequent designs use either a very complex coprocessor and a very simple processor or vice versa, a high-end processor and a very simple coprocessor. In both cases, it is not necessary to provide a very powerful coupling of both because wasting resources on either the processor or the coprocessor does no harm, because it is a cheap resource. Therefore, either loose coupling or tight coupling dominate.

Today's processors are optimized to reach very high frequencies. This requires a high design effort. To make maximal use of this effort, the processors are designed for general purpose. If a processor is used in a device with special processing requirements a coprocessor can be used to provide special purpose instructions and functions which are typical for that given problem. Since certain instructions or functions of the coprocessor architectures are not called as frequently as the general purpose instructions, a coprocessor may run at a lower clock frequency than the processor itself. Furthermore, coprocessor functions can be more complex than the instructions of a general purpose processor. In the past floating point arithmetic has been implemented in a coprocessor, which today is part of many processors. An example of a processor-coprocessor system is introduced in “MIPS 64(Trademark) 5Kf(Trademark) Synthesizable Core for SoC Designs”, Morton Zilmer, MIPS Technologies Inc., Embedded Processor Forum Jun. 12, 2001, retrieved and accessed on the Internet http://www.mips.com/content/PressRoom/TechLibrary/Presentations/MIPS64_{—}5Kf_Presentation_{—}5-22-01.ppt.

For networking, coprocessors are used for checksum computation, encryption or tree search. The computation time of such a function can vary strongly depending on the parameters, the environment, e.g. competition for shared memory access, or previous operations on the same coprocessor (content of caches).

In effect, it is not possible or practicable to use programs on the general purpose processor which assure the completion of coprocessor operation at the time the program accesses the results. At the same time, the time required for executing a program segment varies, too, because of superscalarity, caching and interrupts interfering with the program execution.

### SUMMARY OF THE INVENTION

Due to the increasing discrepancy between processor cycle time and access time to external memory, multithreaded processors are increasingly used. For this reason, a synchronization between a processor executing a program and a coprocessor is necessary. This synchronization can be done using only software, only hardware or a combination of software and hardware.

A multithreaded processor manages several program threads at the same time and executes instructions from any of the present threads if they are ready. In connection with a coprocessor, multithreading can be used to exploit the processor capabilities by other threads when one thread is waiting for results from a coprocessor. In the following, the term thread is used as synonym for what is also called a routine, a set of instructions, a task or a process according to technical language.

Therefore, one object of the invention is to provide a method and a system for synchronizing one or several processors and one or several coprocessors such that a clear architectural semantic is provided while both components, processor and coprocessor work at a high efficiency.

According to different aspects of the invention, the object is achieved by methods for synchronizing a processor and a coprocessor with the features set forth in the appended claims.

Furthermore, for practical reasons the impact on the design of the processor should be as small as possible.

According to one aspect of the invention, a method for synchronizing a processor and a coprocessor comprises the following steps. The processor and coprocessor are working off a thread, wherein this thread comprises a thread control instruction for controlling the timing of said thread. When the processor executes the thread control instruction the thread is stopped with the help of the thread control instruction until a wake up signal from the coprocessor allows the continuation of working off of the thread.

According to another aspect of the invention, a method for synchronizing a processor and a coprocessor is provided comprising the following steps. While the processor and coprocessor are working off a thread, the processor checks the availability of a result of an instruction, which the coprocessor has to deliver, up till the result is available. If the result is available, the processor fetches the result and continues working off the thread.

The device for synchronizing a processor and a coprocessor according to the invention comprises a processor interface connected to the processor for transmitting a thread control instruction from the processor to the processor interface and for receiving a continuation signal from the processor interface. The device further comprises a coprocessor interface connected to the coprocessor and to the processor interface for transmitting a wakeup signal to the processor interface indicating that the coprocessor has finished the execution of an instruction for which the processor is waiting for.

Advantageous further developments of the invention arise from the characteristics indicated in the appended patent claims.

A method according to an embodiment of the invention comprises the following steps. If the thread control instruction has been executed, it is checked whether the contents of a thread identification register is equal to a parameter of the thread control instruction, and if this is the case, the processor is allowed to continue working off the thread, otherwise the thread identification register is set to the identification of the last executed instruction and a wait register is set to a state indicating that said thread execution has to wait.

A method according to another embodiment of the invention comprises the following steps. If the wake up signal has occurred, it is checked whether the thread is still running, and if this is the case the wait register is set to the value of the wake up signal and it is checked whether the contents of the thread identification register is equal to a parameter of the thread control instruction. If this is not the case, the processor is allowed to continue working off the thread, otherwise the thread identification register is set to: thread is running.

Furthermore in a method according to an embodiment of invention the thread can be worked off in several pipeline stages, wherein the thread control instruction takes effect in one of the first pipeline stages.

A method according to an embodiment of the invention comprises the following step. The control instruction is removed or replaced by a no operation instruction when the execution of the thread is continued.

In a method according to an embodiment of the invention the processor and coprocessor can also work off several threads, wherein for each thread, a thread identification register and a wait register are provided.

In another embodiment of the method according to the invention, the method comprises the following steps. If several results are requested by the processor, the coprocessor stores the availability of each result in a mask register, and if the information in the result register indicates that all results are available the wake up signal is created. Advantageously with that, several requests between processor and coprocessor can be synchronized.

As an extension of the method according to the invention a stopped thread can be restarted and an exception signal can be generated in case the time said thread is stopped is longer than expected in normal operation. With that, a higher reliability can be achieved.

In an embodiment of the device for synchronisation according to the invention, the coprocessor interface can comprise a command-buffer for storing commands, which still have to be executed.

In a further embodiment of the device for synchronisation according to the invention, the coprocessor interface can comprise register tags.

In the device according to the invention, the thread control instruction can be transmitted by an instruction decoder of the processor to the processor interface.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures include:

FIG. 1 a dependency circle between a processor and a coprocessor,

FIG. 2 a block diagram of a synchronisation interface between a processor and a coprocessor according to the invention,

FIG. 3 a block diagram showing the communication between two processors and two coprocessors of a multi-processor system,

FIG. 4 a flow chart showing the steps running in the processor interface after a stopthread instruction is executed,

FIG. 5 a flow chart showing the steps running in the processor interface after a wake up signal is received from the coprocessor interface, and

FIG. 6 a flow chart for an alternative method for synchronizing the processor and coprocessor.

### DETAILED DESCRIPTION OF PREFERRED EMBODIMENTS

A combined hardware and software approach is employed which provides the following characteristics. First, the use of processor capabilities is maximized and secondly, an efficient programming model for use of the coprocessor is provided. Finally, the execution pipelines of the processors are not filled with uncompleted instructions when a thread waits for the coprocessor. This advantage is very important. A processor running at a high clock frequency cannot contain big buffers for uncompleted instructions. E.g. if the program of a waiting thread would imply an instruction which cannot complete, the affected pipeline would soon not be usable anymore.

Clear program semantics implies that from the point of view of a program thread there is a point in the program where it is guaranteed that a valid result of a coprocessor computation is available to the thread, for instance, that the result is stored in a register, a conditional branch can be taken dependent on the outcome of a computation or that any exceptions caused by computation errors in the coprocessor have been detected and raised. In one way or another, e.g. through a request instruction, at a position in a program before such a point of guaranteed result availability, the coprocessor should have been assigned to deliver a particular result. Examples are read instructions, which access a coprocessor register, a test instruction, such as a compare, or some kind of synchronization instruction (exception barrier). These methods should be known to someone skilled in the art. According to the initial comments under the section background of the invention the timing between the request point and the point of guaranteed result availability is uncertain on both sides. This means that either the program thread approaches the point of guaranteed result availability before the coprocessor does or vice versa. In the first case the thread has to be blocked until the defined condition is met. If there are several processors sharing one coprocessor or other components like busses are used, another factor of uncertainty is added between the processor and the coprocessor.

In a processor, the execution of instructions is organized in several pipeline stages. An example sequence of eight stages S1 to S8 includes the following:

S1: Next instruction address computation including branch prediction
S2: Instruction fetch
S3: Instruction decode
S4: Instruction issue (decide on which pipeline to execute instruction)
S5: Operand read (means read from register set)
S6: Instruction dispatch (decide, which instructions to execute next)
S7: Instruction execute (in a superscalar processor parallel in several
pipelines)
S8: Result write-back to register file
Note that usually some of these steps last longer than one clock cycle and therefore occupy more than one pipeline stage in modern processors. Up to 20 pipeline stages are found.

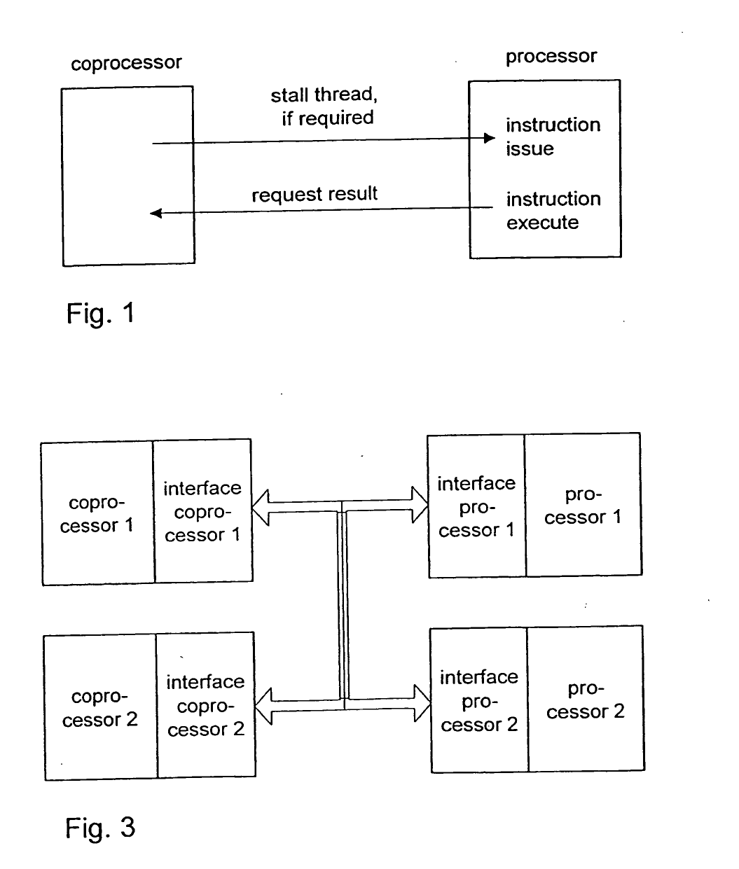

From the view of timing, it is usually increasingly difficult to stop an instruction the later or lower it is in the pipeline. In a multithreaded processor, these steps are virtually performed on several logical processors, which share the expensive resources, e.g. caches and execution units. Therefore, at one of the early pipeline stages S2-S4 or S6 the processor selects among the instructions from the several threads it executes. For instance, if there is only one instruction cache with one read port only one thread can be served by reading its next instruction(s). For this reason, if one thread is stopped, the processor should exclude this thread in any such decisions where resources are shared between several threads. The request of results from a coprocessor is a particular case of the instruction execution, i.e. it takes effect at a late pipeline stage S7. When considering only one processor and one coprocessor, a dependency circle results which is illustrated in FIG. 1.

The execution of the request instruction generates a signal to the coprocessor. The coprocessor can then determine whether the result is available or whether a considerable time is expected to be needed until the result can be delivered to the processor. In the latter case, signaling from the coprocessor to the processor can stop a thread. This takes effect in an early pipeline stage, in FIG. 1 it is the instruction issue, but it can be as well the instruction dispatch, the instruction fetch, etc. Since the waiting takes effect on a per-thread basis all signals between the processor and the coprocessor have to identify the thread they relate to.

To meet the advantage of a minimal impact on the design of the processor, the instruction which does the request to the coprocessor can typically not be distinguished from other instructions which are not related to the coprocessor. A typical case is a store instruction, i.e. the processor stores the request into a register of the coprocessor. Therefore, it is not possible to stop the thread of issuing further instructions after the request instruction automatically by identifying the request instruction. This has the problem that further instructions are issued into the later pipeline stages before the signal from the coprocessor can arrive at the processor's issue stage. These instructions cannot assume the availability of the result from the coprocessor. A large number of instructions between the request and the availability of the result are an undesirable property of the programming model because it requires mixing unrelated aspects of a program together.

To solve this problem two alternative solutions are proposed, the first one introduces an additional instruction to stop a particular thread, called a stopthread instruction in the following, and another solution without this stopthread instruction.

The introduction of a new instruction needs some changes of the processor core, namely at least the instruction decoder. However, the use of this stopthread instruction reduces the program size and provides a higher processor efficiency compared to the proposal without this stopthread instruction. Both proposals have common solutions on the way threads are distinguished by the coprocessor and how individual request/answer pairs are distinguished. They can both use the same methods on the coprocessor side which are explained later.

Explanation of the Stopthread Instruction

As the name suggests the stopthread instruction stops the thread by which it is executed until a corresponding external signal, called wakeup signal from the coprocessor allows continuation. The semantics of this stopthread instruction is that exactly the instructions following the stopthread instruction are not executed before the wakeup signal arrives. All instructions before the stopthread instruction are executed immediately up to processor scheduling restrictions. The stopthread instruction can either be removed directly behind the instruction decoder S3 or because this is unusual and might complicate the processor design it can behave like a NOOP (no operation) instruction in later pipeline stages. This implies that the stopthread instruction takes effect in the early pipeline stages in contrast to the later ones like all other instructions.

In particular, if several instructions are decoded in parallel in a superscalar processor, the instructions which are logically later than the stopthread instruction have to be stopped, while the instructions logically before the stopthread instruction have to continue. Care has to be taken with speculatively executed instructions such as instructions after a conditional branch which is followed by a branch predictor.

To ease the complexity of the processor design the following convention on the placement of the stopthread instruction can be used:

Stopthread placement conventions:
1. When k instructions are decoded in parallel with the help of k parallel decoders, restrict the address of a stopthread instruction modulo k*(size of an instruction). For instance, on a machine with 4-byte instructions, like PowerPC or MIPS, stopthread instructions might only be legal on addresses dividable by 8 or 16. In this way, the stopthread instruction can only occur on one of the k parallel decoders and there is only one pattern with regard to the relative position of other instructions.
2. A stopthread instruction may be either in the statically non-predicted path of a conditional branch or have a minimum distance to a previous conditional branch.
3. A stopthread instruction may have a minimum distance to instructions which might raise an exception, e.g. load or store, to an address which has not been accessed recently, divide instructions etc.

These conventions can be enforced by the compiler or they are localized in a vendor-provided library which represents the application programmer interface of the coprocessor.

Another object in connection with the use of the stopthread instruction is the association of the result request and the stopthread instruction. The intended sequence as described before is that the processor first executes the result request and puts the thread asleep with the stopthread instruction. Because of the latency in the processor, on the interconnection to and from the coprocessor and in the coprocessor the signal to wake up the processor should arrive after the thread has been put asleep, even if the result is immediately available in the coprocessor.

However, if there is a considerable delay between the result request instruction execution and the stopthread instruction a situation can occur in which the thread would be stopped after the signal to wake it up has already arrived. This delay can be caused by an instruction cache miss of the stopthread instruction or due to the way the multithreaded processor selects the individual threads. Without further handling this situation could lead to an ultimate stopping of the thread, which should be avoided.

There are mainly two options for doing this; both can be applied together as well.

The first option is to avoid the delay between the result request and the stopthread instruction. This can be achieved by controlling the way the instruction decoder (where the stopthread takes effect) is scheduled and either a placement restriction like the stopthread placement convention 1 before or by guaranteeing the presence of the particular cache line, e.g. by locking.

The second method to deal with this problem is by associating the stopthread instruction and the wake up signal from the coprocessor. By doing this, it can be figured out whether a stopthread instruction should take effect (put the thread asleep) or not. The identification needed for the association is passed to the coprocessor along with the result request. In particular the identification of the result itself, such as a register number or a condition code, can be used. To allow this association, the stopthread instruction needs a parameter. Because the stopthread instruction typically takes effect before the register read stage (step 5 in the above mentioned pipeline stage organization), this parameter has to be immediate, i.e. encoded in the instruction. Because of this, indirectly identified results cannot be combined as a stopthread association identifier, and a separate identification has to be used.

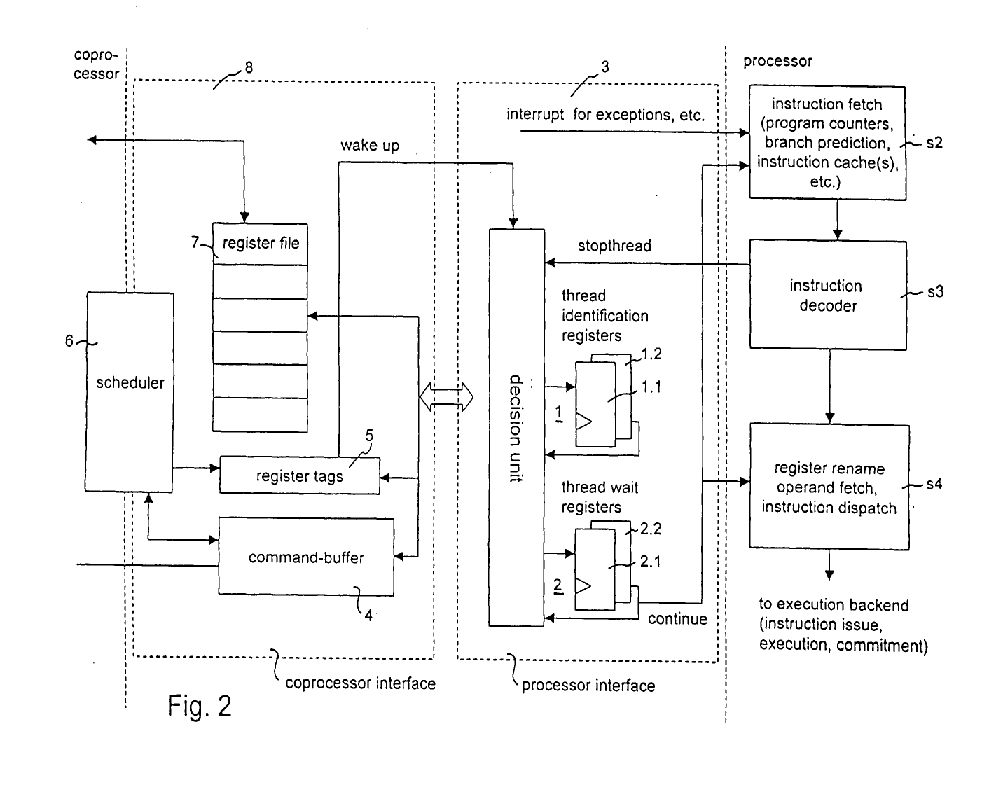

The overall structure of the synchronization interface for a processor and a coprocessor is shown in the FIG. 2. With reference to FIG. 2, a first part of the synchronization interface is formed by a coprocessor interface 8, which is directly connected to the coprocessor while a second part of the synchronization interface is formed by a processor interface 3 which is directly connected to the processor. Via the coprocessor interface 8 and the processor interface 3 the communication and synchronization of the processor and the coprocessor is established. On the right hand side of FIG. 2, the pipeline stages S2, S3 and S4 including the instruction fetch, instruction decoder, and operand access are shown. The relevant stage of instruction decode has been separated; it generates a thread control signal called stopthread for showing the detection of a stopthread instruction to the interface side. The processor interface 3 includes a thread wait register 2.1, 2.2 for each thread, which stores whether a thread is in stopped or running state. All thread wait registers 2.1, 2.2 to 2.N are summarized with the reference sign 2. Furthermore, a thread identification register 1.1, 1.2 per thread stores the identifier of the previous stopthread instruction or the previous wakeup signal from the coprocessor. In the embodiment depicted in FIG. 2, two thread identification registers 1.1, 1.2 each for one thread are provided. All thread identification registers 1.1, 1.2 to 1.N are summarized with the reference sign 1.

The number N of thread wait registers 2 depends on the number of threads which have to be handled and is of course not limited to the two registers 2.1 and 2.2. The same is valid also for the identification registers 1.

The value range of the thread identification register 1.1, 1.2 has to include a value for initialization. A good way to do this is to use a value which cannot be used with the normal result request operation. After reset or an otherwise started initialization, e.g. in a error situation, all thread wait registers 2.1, 2.2 should be initialized as awake and the thread identification registers 1.1, 1.2 should take the mentioned initial value. If such an initial value is not available, a convention between architecture and compiler is needed such that hardware and software start with different identifiers.

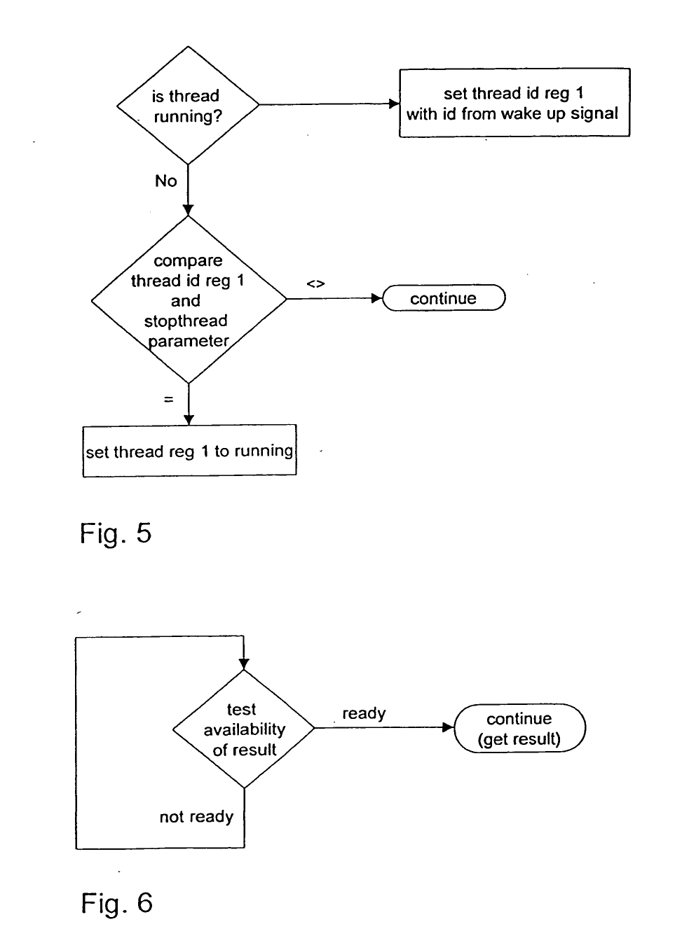

If a wakeup signal arrives for a thread which is (still) awake the identifier of the wake up signal is written to the thread identification register 1.1, 1.2. The corresponding flow chart is shown in FIG. 5. If subsequently a stopthread instruction is executed, the identifier parameter from the stopthread instruction is compared with the value in the identification register 1.1, 1.2 and if the same value is found in the identification register 1.1, 1.2, the stopthread instruction does not take effect, i.e. the thread stays awake. Otherwise, the identification parameter of the stopthread instruction is written to the identification register 1.1, 1.2. In contrast, if a wakeup signal arrives and the thread is stopped, the wakeup signal value is compared with the value in the identification register 1.1, 1.2. If it is equal, then the thread is woken up. Otherwise, the thread remains asleep.

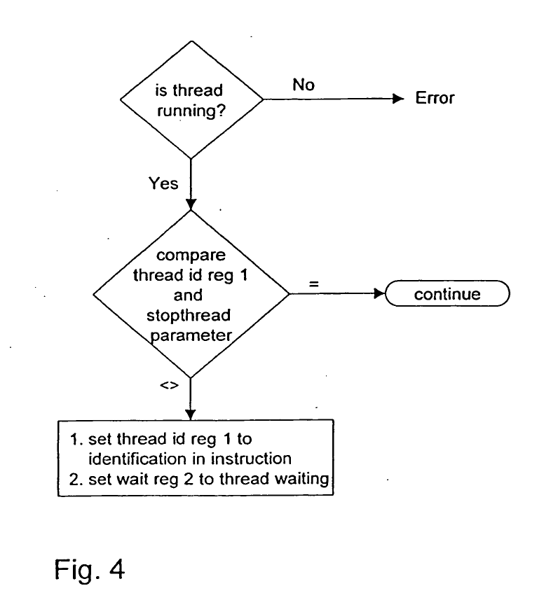

The way a thread is handled in the processor interface 3 when a stopthread signal arrives from the processor is illustratively shown in the flow chart in FIG. 4.

Note that both operations, stopthread instruction handling and wakeup signal reaction have to be carried out independently for each thread in the processor synchronization interface 3.

To achieve a higher reliability the thread wait register 2 can be coupled with a timer. The timer which is not shown in FIG. 2 restarts a stopped thread and generates an exception signal for it, in case the blocking time, i.e. the time during the thread is stopped, is longer than expected in normal operation.

Multi-Request Operation With Stopthread Instruction

So far only isolated requests and synchronization for a single result has been discussed. If several results are requested by one thread from one coprocessor, care has to be taken that the synchronization operations do not interfere with each other. Furthermore, it can be desirable to combine the synchronization for all the results such that only one stopthread instruction is needed. The combination of the completion signal can be either done in the coprocessor or in the processor interface 3.

As one implementation option, the combination of requests is done explicitly, i.e. the result request provides a list of results and requests a common signaling. In this way, the synchronization aspect is the same as before with a single request, only the type of the requested result is different. However, this calls for an increased hardware effort in the coprocessor.

Two different methods are explained in the following, which allow the combination of the waiting while the coprocessor remains unchanged, i.e. it provides an individual wakeup signal for each result request.

A) In this variant, a mask vector is used and the returning wakeup signals flip individual signal bits. Only when all indicated positions of the mask vector stored in a mask register have been signaled, the thread is woken up. The value for the mask register is provided with the stopthread instruction. To provide this, the identification parameter of the result requests and of the stopthread instruction are split up to indicate the group of commonly handable requests and the mask vector initial value or the individual bit for signaling respectively.

B) An alternative method uses a counter per thread. This counter is used as a semaphore. Semaphores are a traditional synchronisation concept, introduced by E. W. Dijkstra, “Cooperating sequential processes”, Programming Languages, 43-112, Academic Press, 1968. The stopthread instruction decrements (subtract one from) the thread's semaphore counter. If it reaches zero, the thread is stopped. The signal from the coprocessor to awake a thread increments (add one to) the thread's semaphore counter. If the counter is greater than zero after the increment, the thread is enabled to run. The stopthread instruction can be extended to subtract a parametric value. Instead of one counter, several counters per thread can be used. In this case, the request, the signal from the coprocessor and the stopthread have to identify the counter(s) they refer to. This option allows combining the retrieval of several results with one waiting period (one stopthread instruction and one thread restart) even when the results are from several different coprocessors.

In both cases (A and B) for initialization extra means such as a control register are needed to initialize the counter or the identifier register.

Operation Without Stopthread Instruction

There are several reasons why the introduction of a new instruction can be undesirable. For instance, if several instruction decoders are used in parallel to achieve a very high instruction throughput, the signal transferring the occurrence and parameters of the stopthread instruction would have to be replicated as well. This could increase the complexity of the processor interface 3 as shown in FIG. 2.

Furthermore, processor instruction sets are standardized, such as PowerPC Book E, and the introduction of a new instruction, as for example a stopthread instruction, requires additional effort in processor design, documentation, tool development, and programmer education. For these cases the following method working without a stopthread instruction is introduced.

The coprocessor provides a method to allow the processor to test the availability of the requested result as it is shown in the flow chart in FIG. 6. For instance, the coprocessor can provide a register which contains one digit with this meaning.

Other methods are interfaces to the condition code register of the processor. In order to retrieve a result from the coprocessor, the processor has to execute the following program:
1: Signal result request to coprocessor;
2: while (result not yet available from coprocessor) do;
3: Get result from coprocessor;

A usual method to access the coprocessor consists of attaching the coprocessor in the same way as the input-output or memory devices. In consequence, the three interactions with the coprocessor use instructions for input or output or memory access. If the memory interface is used, it has to be ensured that the processor cache is inhibited on the affected address region. Using instructions for the PowerPC architecture, the above mentioned program segment can be written in assembler notation as follows:

| | |
|---|---|
| | Ii r1,#req |
| | sw r1,coproreq |
| L1: | lw r1,statusreg |
| | andi. r2,r1,#rdy |
| | bne L1 |
| | lw r1,resultreg |

wherein
“req” denotes the identification of the requested results, and
“coproreq”, “statusreg” and “resultreg” are register addresses of the
coprocessor where the request identification, status (availability of result),
and the result itself are located.

Depending on the size of the result, the register addresses “statusreg” and “resultreg” can be the same. Since the register address “coproreq” is written to and the other two registers are read, they can be located at the same address as well.

This code does not reveal the advantage of the synchronization interface and the use of the processor capabilities by other threads when the affected thread waits for the coprocessor. In fact, the operation of the processor synchronisation interface 3 is very similar as with the use of the stopthread instruction, with the difference that the stopping of the thread is signaled from the coprocessor as well instead of the instruction decoder.

In a multithreaded processor instructions from several threads can be selected for execution. Therefore, it can well happen that the signal for stopping the thread arrives before the first instruction from the waiting loop (the one at the label L1 in the assembler code) is issued for execution. Of course in total the whole loop is executed at least once.

If several results are requested together, the condition in the waiting loop represented by the value #rdy can be modified.

If the thread priority can be controlled by the user program as it is described in EP 02028545.8 (corresponding to U.S. patent application Ser. No. 2004/0154018 A1) together with requesting the result the thread priority can be decreased. This increases the probability that the waiting loop is interacted only few times.

Details on Coprocessor Site Interface 8

Since coprocessors tend to be more heterogeneous than processors, a general purpose interface is not always applicable. For two classes, memory intensive coprocessors such as garbage collectors, memory management, or data structure walkers and register-based computation engines such as floating point unit or SIMD (Single Instruction Multiple Data) unit (SSE, AltiVec etc.) details are given.

In FIG. 2 the left part illustrates a possible structure of the coprocessor side interface 8 for a register oriented coprocessor. In a register oriented coprocessor all commands to the coprocessor including result requests are register related. Providing parameters is done by transferring data to a coprocessor register, e.g. by reading a value from memory. Similarly results are transferred from a coprocessor register including a status register to include results of comparisons etc. to memory or to a register of the general purpose processor.

Because the coprocessor cannot process request commands as fast as they can arrive, the coprocessor interface 8 includes a command buffer 4 to record outstanding commands. Whether a result is available depends on the fact whether there is a pending command in the command buffer 4 or in the coprocessor. Therefore a set of tags 5 for each register is used. If a command which modifies one or several registers is written to the command buffer 4, the tag(s) 5 of the corresponding register(s) is/are marked. Result requesting commands have to wait until the tag in the tag register 5 is freed. The scheduler 6 which selects commands from the command buffer 4 can regard this and prefer commands which are necessary for delivering a result. The coprocessor core fetches values from the register file 7, does its computations and stores the results back in the register file 7.

Details on the Processor Execution Pipeline

As mentioned above, it is an advantage that with the help of the interface according to the invention the impact on the design of the processor is minimized. Therefore, the execution pipeline of the processor should be impacted as little as possible and therefore the execution pipelines of the processor are close to the state of the art in processor design.

Since the communication with the coprocessor is mainly done with standard processor instructions such as load and store, input and output (for instance on a x86 type processor) or move-to/move-from device control register (for a PowerPC) or move-to/move-from special purpose register (e.g. for a PowerPC, 80C166 or others) no extra design effort is needed.

When using memory related operations, such as load or store, the data cache has to be disabled on the regions used to address the coprocessor.

To speed up the retrieval of the result, a single result cache register can be used, into which the result is transferred by the coprocessor. When the processor executes a load instruction, this result cache register is checked for the correct value and is invalidated afterwards.

Most of this structure is already present in many processors, which allow several outstanding writes. Because loads are typically processed with higher priority to allow fast availability of the result, the address of a memory read has to be compared to the addresses of uncompleted logically earlier write operations. Therefore, the result cache register behaves like an additional outstanding load. This extension of the processor pipeline should be possible to be performed at the native clock rate of the processor with little additional area and design cost.

The only difference to the outstanding write buffers is the clear after use.

To speed up the waiting loop in the interface variant without the stopthread instruction the same can be done with the status register. In this case the result cache register should not be cleared after use but the coprocessor should forward every change of the status register value to the processor.

Supporting Several Coprocessors

If the proposed synchronisation mechanisms are applied in a situation where several distinct coprocessors are used together with one or several processors, as it is shown in FIG. 3, the result request should select the coprocessor as well. Since there are several coprocessors, there are several signal inputs at the processor side interface and the stopthread instruction has to identify the coprocessor for which to wait.

Having illustrated and described a preferred embodiment for a novel method and apparatus for, it is noted that variations and modifications in the method and the apparatus can be made without departing from the spirit of the invention or the scope of the appended claims.

The content of the present application is preferably related to improvements on the method and apparatus for determining a priority value for a thread for execution on a multithreading processor system disclosed and claimed in EP 02028545.8 (U.S. patent application Ser. No. 2004/0154018 A1) being assigned to the assignee of the present invention. The disclosure of this related patent is fully incorporated herein by reference.

### Reference Signs

1 thread identification registers
1.1 first thread identification register
1.2 second thread identification register
2 thread wait registers
2.1 first thread wait register
2.2 second thread wait register
3 processor interface
4 command-buffer
5 register tags
6 scheduler
7 register file
8 coprocessor interface
s2 second pipeline stage
s3 third pipeline stage
s4 fourth pipeline stage

1. A method for synchronizing a processor and a coprocessor, comprising the steps of:
said processor is working off a thread with the collaboration of said coprocessor,
controlling the timing of said thread wherein said thread comprises a thread control instruction for controlling the timing,
said processor executing said thread control instruction when said thread is stopped with the help of said thread control instruction until a wake up signal from the coprocessor allows the continuation of working off of said thread.

2. The method according to claim 1, further comprising the steps of:
wherein if said thread control instruction has been executed, checking whether the contents of a thread identification register are equal to a parameter of said thread control instruction, and
if this is the case, said processor continuing working off said thread, otherwise said thread identification register is set to the identification of the last executed instruction and a thread wait register is set to a state indicating that said thread execution has to wait.

3. The method according to claim 1, further comprising the steps of:
wherein if said wake up signal has occurred, checking whether said thread is still running, and
if this is the case, said wait register is set to the value of said wake up signal and checking whether the contents of said thread identification register are equal to a parameter of said thread control instruction, and
if this is not the case, said processor continuing working off said thread, otherwise said thread identification register is set to a state indicating that said thread is running.

4. A method according to claim 1, wherein said thread is worked off in several pipeline stages,
wherein said thread control instruction takes effect in one of the first pipeline stages.

5. A method according to claim 1,
wherein said control instruction is removed or replaced by a no-operation instruction when the execution of said thread is continued.

6. A method according to claim 1,
wherein said processor and said coprocessor are working off several threads,
wherein for each thread a thread identification register and a thread wait register are provided.

7. A method according to claim 1, further comprising the steps of:
wherein if several results are requested by said processor, said coprocessor storing the availability of each result in a mask register, and
if the information in said result register indicates that all results are available, creating said wake up signal.

8. A method according to claim 1,
wherein a stopped thread is restarted and an exception signal is generated in case the time said thread is stopped is longer than expected.

9. A processor designed for executing a method as claimed in claim 1.

10. A computer program element comprising computer program code which when loaded in a processor coupled with a coprocessor configures the processor to perform a method as claimed in claim 1.

11. A program storage device readable by machine, tangibly embodying a program of instructions executable by the machine to perform method steps for synchronizing a processor and a coprocessor, as recited in claim 1.

12. A method for synchronizing a processor and a coprocessor, comprising the steps of
said processor working off a thread with the collaboration of said coprocessor,
checking the availability of a result of an instruction, which said coprocessor has to deliver, up until said result is available,
if the result is available, said processor fetching the result and continuing working off said thread.

13. A method according to claim 12,
wherein said coprocessor delivers an availability information stored in a register, and
wherein the contents of said register can be checked by said processor.

14. A processor designed for executing a method as claimed in claim 12.

15. A computer program element comprising computer program code which when loaded in a processor coupled with a coprocessor configures the processor to perform a method as claimed in claim 12.

16. A program storage device readable by machine, tangibly embodying a program of instructions executable by the machine to perform method steps for synchronizing a processor and a coprocessor, as recited in claim 12.

17. A system for synchronizing a processor and a coprocessor,
comprising: a processor and a coprocessor,
wherein said processor is connected to a processor interface for transmitting a thread control instruction to said processor interface and for receiving a continuation signal from the processor interface,
wherein said coprocessor is connected to a coprocessor interface, which in turn is connected to said processor interface for transmitting a wakeup signal indicating that said coprocessor has finished the execution of an instruction for which said processor is waiting for,
wherein said processor interface comprises for each thread a thread identification register and is formed such that the processor interface delivers said continuation signal to said processor when the corresponding thread is allowed to be continued.

18. A system according to claim,
wherein said coprocessor interface comprises a command-buffer.

19. A system according to claim 15,
wherein said coprocessor interface comprises register tags.

20. A system according to claim 15,
wherein said thread control instruction is transmitted by an instruction decoder of said processor to said processor interface.
